(19) United States
(12) Patent Application Publication
(10) Pub. No.: US 2004/0110062 A1
(43) Pub. Date: Jun. 10, 2004

(54) Electrode using improved active material for battery and capacitor

(75) Inventors: Gaku Harada, Tokyo (JP); Toshihiko Nishiyama, Tokyo (JP); Masaki Fujiwara, Tokyo (JP); Shinako Okada, Tokyo (JP); Masato Kurosaki, Tokyo (JP)

Correspondence Address: YOUNG & THOMPSON, 745 SOUTH 23RD STREET 2ND FLOOR, ARLINGTON, VA, 22202

(73) Assignee: NEC TOKIN CORPORATION, MIYAGI (JP)

(21) Appl. No.: 10/716,672

(22) Filed: Nov. 20, 2003

Related U.S. Application Data
(63) Continuation of application No. 09/528,711, filed on Mar. 20, 2000.

(30) Foreign Application Priority Data
Mar. 19, 1999 (JP) 11-076573

(51) Int. Cl. H01M 4/60; C08G 73/00

(52) U.S. Cl. 429/213; 528/422

(57) ABSTRACT

The present invention provides a conductive polymer comprising a polybiphenylaniline which is doped with dopant comprising at least an acid having a single site of a group which dissociates proton.

### BACKGROUND OF THE INVENTION

The present invention relates to an electrode for, a battery or a capacitor, and more particularly to an electrode using polybiphenylaniline as an active material for a battery or a capacitor.

A secondary battery is used for a battery for potable computers and mobile phones. The secondary battery is required for reduction in weight, increase in power, long life-time and formability in various shapes as well as flexibility. In order to response to the above requirements, it has been known in the part to which the invention pertains that polymer is used as an active material of the battery. The battery using polymer as the active material is so called to be polymer battery.

In Japanese laid-open patent publications Nos. 63-36319, 63-56521, 1-144562 and 2-638, it is. disclosed that polyaniline is used as the active material in a non-aqueous solvent in a positive electrode of a lithium battery. Polyaniline is represented by the following general formula.

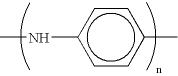

The following table 1 shows acceptable doping rates of individual materials.

TABLE 1

| Polymer | acceptable doping rate (%) |
|---|---|
| Polyacetylene | 7 |
| Poly-p-phenylene | 40 |
| Polypyrrole | 18 |
| Polyfuran | 26 |
| Polythiophene | 24 |
| Polyaniline | 50 |

From the above Table 1, it can be understood that polyaniline is superior in acceptable doping rate and stability than polyacetylene, poly-p-phenylene, polypyrrole, polyfuran, and polythiophene.

A commercially available coin-shaped polyaniline lithium secondary battery shows a high voltage of 3.0V, a high discharge capacity of 69 mAh/g, a long cyclic lifetime of over 1000 cycles and a low self-discharge rate of −15% per one month. This battery uses a non-aqueous solvent such as propylene carbonate. This battery is disadvantageous in-low power density, need of packaging the same to protect the battery from moisture, and generation of gas due to electrolysis of moisture included in an electrolytic solution.

In order to have solved the above three disadvantages, it has been known to use an aqueous solvent for an electrolytic solution. This technique is disclosed in Japanese laid-open patent publication No. 3-62451. A polyaniline doped with an organic dopant is used for a positive electrode, whilst zinc is used for a negative electrode. Zinc sulfate is used for an electrolytic solution. If a non-aqueous solvent is used for the electrolytic solution, then polyaniline shows slow-rate oxidation reduction reactions in the non-aqueous solvent because the oxidation reduction reactions correspond doping de-doping reactions, resulting in a low power density. However, in accordance with the above conventional technique, an aqueous solvent is used for the electrolytic solution, whereby the oxidation reduction reactions of polyaniline correspond to absorption desorption reactions of protons, for which reason polyaniline shows high-rate oxidation reduction reactions in the aqueous solvent, resulting in a high power density.

As described above, polyaniline is higher than other p-type conductive polymers in acceptable doping rate. However, polyaniline is low in reactivity and effective capacity. If the aqueous electrolytic solution is used, an electromotive force is low and an energy density is also low.

In the above circumstances, it had been required to develop a novel electrode for a battery or a capacitor free from the above problem.

### SUMMARY OF THE INVENTION

Accordingly, it is an object of the present invention to provide a novel electrode free from the above problems.

It is a further object of the present invention to provide a novel electrode having an improved active material for allowing a battery or a capacitor to be chemically stable.

It is a still further object of the present invention to provide a novel electrode having an improved active material for allowing a battery or a capacitor to show a good cyclic characteristic.

It is yet a further object of the present invention to provide a novel electrode having an improved active material for allowing a battery or a capacitor to show a low self-discharge rate.

It is moreover object of the present invention to provide a novel electrode having an improved active material for allowing an increased acceptable doping rate.

It is still more object of the present invention to provide a novel electrode having an improved active material for improvement in reactivity of oxidation reduction reactions.

It is yet more object of the present invention to provide a novel electrode having an improved active material for allowing a battery or a capacitor to have an improved appearing capacity.

It is an additional object of the present invention to provide a novel battery free from the above problems.

It is a still additional object of the present invention to provide a novel battery or capacitor to be chemically stable.

It is yet additional object of the present invention to provide a novel battery or capacitor which shows a good cyclic characteristic.

It is further additional object of the present invention to provide a novel battery or capacitor which shows a low self-discharge rate.

It is moreover object of the present invention to provide a novel battery or capacitor using an electrode having an improved active material for allowing an increased acceptable doping rate.

It is still more object of the present invention to provide a novel battery or capacitor using an electrode having an improved active material for improvement in reactivity of oxidation reduction reactions.

It is yet more object of the present invention to provide a novel battery or capacitor which has an improved appearing capacity.

The present invention provides a conductive polymer comprising a polybiphenylaniline which is doped with dopant comprising at least an acid having a single site of a group which dissociates proton.

The above and other objects, features and advantages of the present invention will be apparent from the following descriptions.

### BRIEF DESCRIPTION OF THE DRAWINGS

Preferred embodiments according to the present invention will be described in detail with reference to the accompanying drawings.

FIG. 1 is a fragmentary cross sectional elevation view illustrative of a secondary battery using an improved positive electrode in accordance with the present invention.

FIG. 2 is a diagram illustrative of illustrative of voltage-discharge capacity characteristic of the batteries of the first, second and third examples in accordance with the present invention.

FIG. 3 is a diagram illustrative of illustrative of voltage-discharge capacity characteristic of the batteries of the first, second and third comparative examples.

FIG. 4 is a diagram illustrative of capacity-discharge current characteristic of the batteries of the first, second and third examples in accordance with the present invention, as well as the first, second and third comparative examples.

FIG. 5 is a diagram illustrative of variations of a ratio of the capacity to the initial capacity over the cycle number of the batteries of the first, second and third examples in accordance with the present invention, as well as the first, second and third comparative examples.

### DISCLOSURE OF THE INVENTION

The present invention provides a conductive polymer comprising a polybiphenylaniline.

The polybiphenylaniline is represented by the following general formula:

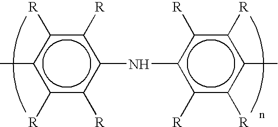

where R is any one of hydrogen atom, halogen atom, hydroxyl groups, carboxyl groups, sulfonic groups, sulfuric groups, nitro groups, cyano groups, alkyl groups, aryl groups, alkoxyl groups, aryloxy groups, amino groups, alkylthio groups, arylthio groups, and heterocyclic groups, provided that individuals of R are not limited to be the same. Namely, individuals of R may be either identical with each other or different from each other.

It is preferable that the polybiphenylaniline is doped with dopant comprising at least an acid having a single site of a group which dissociates proton. Namely, non-polymer acids may be available as a dopant to be doped into polybiphenylaniline, in view that a small dopant size and a small molecular weight are preferable for realizing a high doping rate. The acid as a dopant may, for example, be selected from the group consisting of a sulfuric acid, a hydrochloric acid, a perchloric acid, a benzene sulfonic acid, a p-toluene sulfonic acid, benzenesulfonyl chloride, a dodecylbenzene sulfonic acid, a methane sulfonic acid, a trifluoromethane sulfonic acid, a butane sulfonic acid, a trichlorobenzene sulfonic acid, a naphthalene sulfonic acid, a perfluorobutane sulfonic acid, and a perfluorooctane sulfonic acid.

The above novel conductive polymer may be used as an active material for an electrode.

The above novel conductive polymer may also be used as an electromagnetic shielding material.

The above novel conductive polymer may also be used for a conductive film.

The above novel conductive polymer may also be used for an electro-chromic material for a display device.

The above novel conductive polymer may also be used for an anti-static material.

The present invention also provides an active material including a conductive material described above.

The present invention also provides an electrode using an active material described above.

The present invention also provides a battery using an electrode described above. It is preferable that the battery uses an electrolytic solution including an electrolyte of the same acid as doped into polybiphenylaniline.

The present invention provides an electrode using a conductive material described above. The electrode may be used in a semiconductor device, an electronic device, or an electric device.

Preferred Embodiment

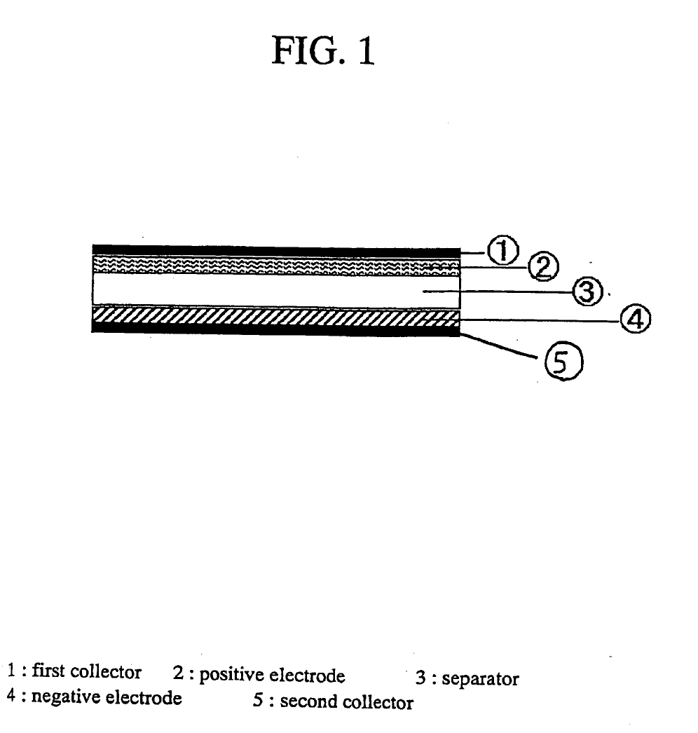

A first embodiment according to the present invention will be described in detail with reference to the drawings. FIG. 1 is a fragmentary cross sectional elevation view illustrative of a secondary battery using an improved positive electrode in accordance with the present invention. The secondary battery has the following lamination structure. A sheet-shaped separator 3 is sandwiched by a sheet-shaped positive electrode 2 and a sheet-shaped negative electrode 3. Laminations of the positive electrode 2, the separator 3 and the negative electrode 4 are sandwiched by first and second sheet-shaped collectors 1 and 5. The separator 3 is immersed with an electrolytic solution as an electrolyte.

The positive electrode 2 includes an active material which comprises a polybiphenylaniline represented by the following general formula:

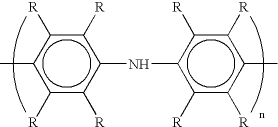

where R is any one of hydrogen atom, halogen atom, hydroxyl groups, carboxyl groups, sulfonic groups, sulfuric groups, nitro groups, cyano groups, alkyl groups, aryl groups, alkoxyl groups, aryloxy groups, amino groups, alkylthio groups, arylthio groups, and heterocyclic groups, provided that individuals of R are not limited to be the same. Namely, individuals of R may be either identical with each other or different from each other.

The polybiphenylaniline may be electrochemically or chemically doped with a dopant by use of a sulfuric acid solution. Available dopant may be an acid which has a single site of a group which dissociates proton. Namely, non-polymer acids may be available as a dopant to be doped into polybiphenylaniline, in view that a small dopant size and a small molecular weight are preferable for realizing a high doping rate. The acid as a dopant may, for example, be selected from the group consisting of a sulfuric acid, a hydrochloric acid, a perchloric acid, a benzene sulfonic acid, a p-toluene sulfonic acid, benzenesulfonyl chloride, a dodecylbenzene sulfonic acid, a methane sulfonic acid, a trifluoromethane sulfonic acid, a butane sulfonic acid, a trichlorobenzene sulfonic acid, a naphthalene sulfonic acid, a perfluorobutane sulfonic acid, and a perfluorooctane sulfonic acid.

The sheet-shaped positive electrode 2 may be formed as follows. Polybiphenylaniline as the active material and a vapor phase epitaxy carbon as a conductive auxiliary substance are mixed at a weight ratio of 4:1 to prepare a mixture. This mixture is further mixed with N-methylpyrolidone to adjust a slurry. The adjusted slurry is sufficiently stirred by a homogenizer and then formed to be a film on the sheet-shaped collector 1 by use of doctor-blade. The film on the sheet-shaped collector 1 is dried in vacuum at a temperature in the range of 120° C.-160° C. for one hour. The film is then pressed by a roll-press machine so that the film has a thickness of about 100 micrometers. The laminations of the film and the collector 1 are cut to form the positive electrode 2.

The negative electrode 4 may be formed by cutting a film an active material such as zinc, polymers, low molecular materials, inorganic materials and metal materials.

The separator 3 is immersed with an electrolytic solution such as a zinc sulfate solution, acid solutions, neutral solutions, and organic solutions. In place of the separator 3 immersed with the zinc sulfate solution, solid-state electrolytes and gelled electrolytes are also available as the electrolyte. The solid-state electrolyte means an electrolyte including no solvent molecules. The gelled electrolyte means an electrolyte obtained by plasticizating the solid-state electrolyte with an electrolytic solution as a solvent, wherein the electrolyte has no electron-conductivity to the electrolytic solution. The gelled electrolyte is thus in liquid-state and has an ion-conductivity. The gelled electrolyte is thus obtained by dissolving the electrolyte with a solvent such as water or organic solvent.

The positive electrode 2 and the negative electrode 4 are placed on opposite surfaces of the separator 3 to form the battery.

Polybiphenylaniline is used for the active material of the positive electrode. Further, the dopant doped into polybiphenylaniline is the specific acid which has a single site of the group dissociating proton. The acid, which has a single site of the group dissociating proton, is small in dopant size, thereby increasing the doping rate and also improve the reactivity of the oxidation reduction reactions. The ratio of the actual capacity to the theoretical capacity is high. For those reasons, the battery is chemically stable. The battery has the good cyclic characteristic. The battery shows a slow self-discharge. The acid as the dopant doped to the polybiphenylaniline improves the reactivity of polybiphenylaniline. The acid, which has a single site of the group dissociating proton, has a small molecular weight, whereby a high capacity in a unit weight of the active material can be obtained.

Polybiphenylaniline has a structure which comprises a skeleton of polyaniline introduced with benzene-rings. This polybiphenylaniline is doped with a dopant of the acid which has a single site of the group dissociating proton, where the dopant has a small size and a small molecular weight, whereby the doping rate is increased. The reactivity of the oxidation reduction reactions were also increased, whereby the ratio of the actual capacity to the theoretical capacity of the battery was also increased. Polyaniline is chemically stable and the battery using polyaniline shows a slow self-discharge and a good cyclic characteristic. Polybiphenylaniline has a similar chemical structure to polyaniline. Polybiphenylaniline is also chemically stable and shows a slow self-discharge the battery using polybiphenylaniline shows a slow self-discharge and a good cyclic characteristic.

It has been know that p-type conductive polymers such as polyaniline, polythiophene, polypyrrole, polyacetylene, poly-p-phenylene and polyfuran are available as the p-type active material for the positive electrode. The p-type conductive polymers have disadvantages in low acceptable doping rate and in allowing the battery to have a low ratio of the actual capacity to the theoretical capacity. The p-type conductive polymers are in chemically unstable whereby the battery is deteriorated in cyclic characteristic. The battery shows a fast self-discharge. Polyaniline is, however, superior in cyclic characteristic and allows the battery to show a slow self-discharge as compared to polythiophene, polypyrrole, polyacetylene, poly-p-phenylene and polyfuran. Polyaniline is also superior in acceptable doping rate and is chemically stable as compared to polythiophene, polypyrrole, polyacetylene, poly-p-phenylene and polyfuran. Polyaniline has 20%-part which contributes to the oxidation reduction reactions, whereby a ratio of the actual capacity to the theoretical capacity is low.

An electrolytic polymerization of polybiphenylaniline is disclosed in J. Electroanal. Chem. 274, (1989), pp. 143-155. In Japanese laid-open patent publication 3-504872, there is disclosed a method of preparing a conductive polymer which has a high thermal stability, wherein aromatic multi-sulfonic acids are doped to polyaniline, its naphthyl and, biphenyl derivatives. Those conductive polymers may be applied to conductive complex, electronic devices, electrical conductors, electrodes, batteries, switching devices, electrical-shielding materials, resistors and capacitors. However, the high thermal stability is not necessarily required for applying the conductive polymer to the battery.

In Japanese laid-open patent publication 3-62451, it is disclosed that multi-sulfonic acid is doped as the dopant to the conductive polymer as the active material, whereby the battery shows a fast self-discharge. This means that it is not preferable to dope the multi-sulfonic acid to the conductive polymer. The multi-sulfonic acids have large molecular weights, whereby the capacity per a unit weight of the active material for the positive electrode is low. The multi-sulfonic acids are, for example, m-benzene di-sulfonic acid, naphthalene di-sulfonic acid, naphthalene tri-sulfonic acid, phtharocyanine tetra-sulfonic acid, pyrene di-sulfonic acid, pyrene tri-sulfonic acid, polyvinyl sulfonic acid, polystyrene sulfonic acid, and Nafion. Those dopants have multi-sites of the group which dissociates proton. Those dopants are thus undesirable due to its large molecular weight and large dopant sizes.

The desirable dopants are small in molecular weight and in dopant size. The desirable dopants to be doped to polybiphenylaniline have a single site of the group which dissociates proton. The desirable dopants are, for example, a sulfuric acid, a hydrochloric acid, a perchloric acid, a benzene sulfonic acid, a p-toluene sulfonic acid, benzenesulfonyl chloride, a dodecylbenzene sulfonic acid, a methane sulfonic acid, a trifluoromethane sulfonic acid, a butane sulfonic acid, a trichlorobenzene sulfonic acid, a naphthalene sulfonic acid, a perfluorobutane sulfonic acid, and a perfluorooctane sulfonic acid.

### EXAMPLE 1

Polybiphenylaniline was used as the active material of the positive electrode. Polybiphenylaniline was doped with a dopant of SO₄. ZnSO₄ was used as an electrolytic solution. Zn was used for the negative electrode.

The sheet-shaped positive electrode 2 may be formed as follows. Polybiphenylaniline as the active material and a vapor phase epitaxy carbon as a conductive auxiliary substance are mixed at a weight ratio of 4:1 to prepare a mixture. This mixture is further mixed with N-methylpyrolidone to adjust a slurry. The adjusted slurry is sufficiently stirred by a homogenizer and then formed to be a film on the sheet-shaped collector 1 by use of doctor-blade. The film on the sheet-shaped collector 1 is dried in vacuum at a temperature in the range of 120° C.-160° C. for one hour. The film is then pressed by a roll-press machine so that the film has a thickness of about 100 micrometers. The laminations of the film and the collector 1 are cut to form the positive electrode 2.

The battery was charged to measure various characteristics thereof. The secondary battery was charged in the range of 1-10C up to 1.5V at a constant current in the range of 1 mA/cm2. The secondary battery was discharged in the range of 1-10C at a constant current in the range of 1-10 mA/cm2, where a theoretical capacity was 153 Wh kg per a unit. weight of the active material of the positive electrode. At the discharge rate of 1C, the actual capacity was 107 Wh/kg per the weight of the active material of the positive electrode. At the discharge rate of 10C, the actual capacity was 45 Wh/kg per the weight of the active material of the positive electrode. A ratio of the actual capacity to the theoretical capacity at the discharge rate of 1C was high, for example, 70%. The ratio of the actual capacity to the theoretical capacity corresponds to the reactivity of the oxidation reduction reactions. The cyclic characteristics were also measured. A cyclic number necessary for dropping the capacity to 80% of the initial capacity of 107 Wh/kg was 1000. A capacity storage characteristic was also measured. After the battery was placed at 25° C. for 30 days, then the capacity was reduced to 60% of the initial capacity.

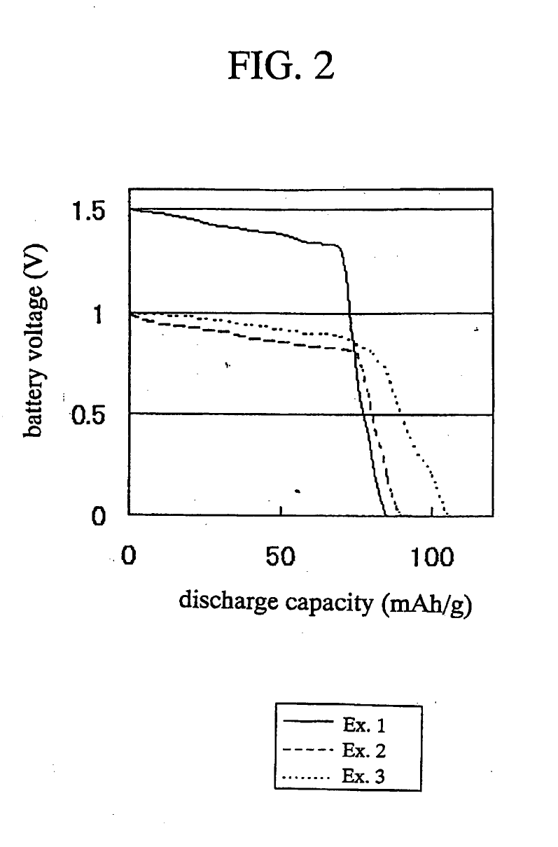

FIG. 2 is illustrative of voltage-discharge capacity characteristic of the above battery of this example. The voltage of the battery is dropped at a high discharge capacity over 70 mAh/g. Namely, the battery keeps high voltage levels in the wide range of discharge capacity.

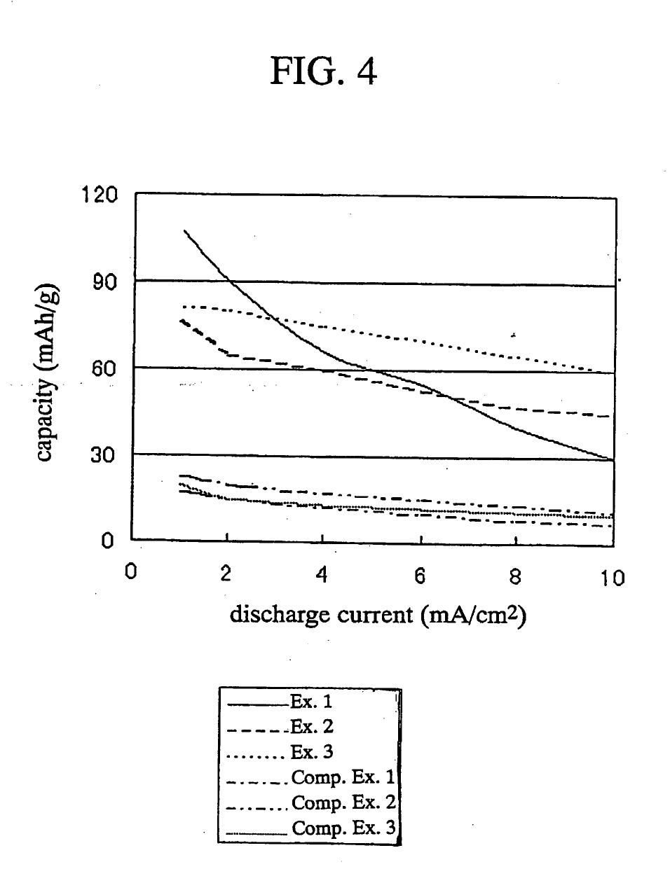

FIG. 4 is illustrative of capacity-discharge current characteristic of the above battery of this example. The capacity of the battery is gently reduced as the discharge current is increased, but the capacity remains high range. At the discharge current was 2 mA/cm², the capacity was 90 mAb/g. At the discharge current was 5 mA/cm², the capacity was 60 mAh/g. At the discharge current was 10 mA/cm², the capacity was 30 mAh/g. The battery shows a good capacity-discharge current characteristic.

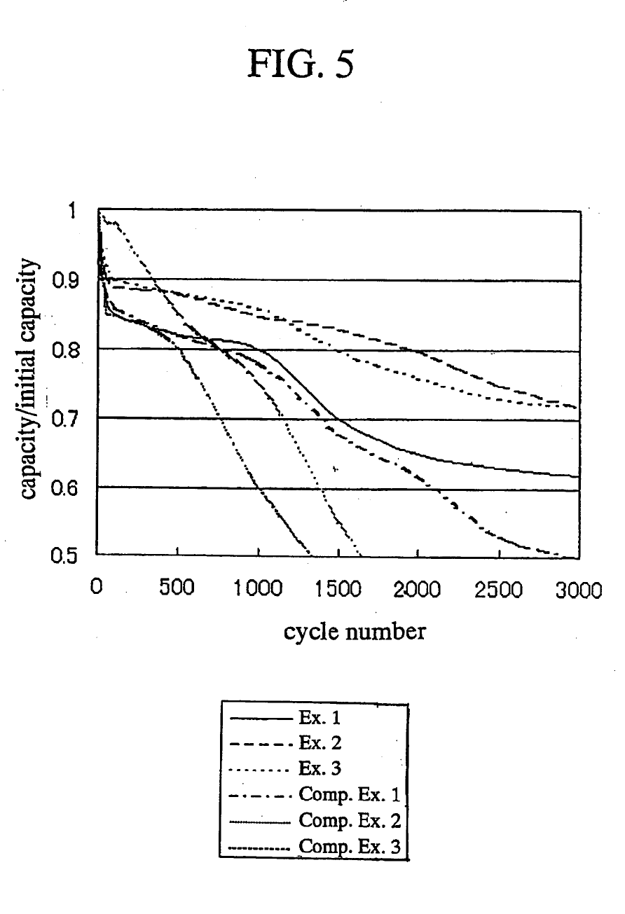

FIG. 5 is illustrative of variations of a ratio of the capacity to the initial capacity over the cycle number of the above battery of this example. As the cycle number is beyond 1000, the ratio of the capacity to the initial capacity is gently decreased. At the cycle number is 3000, the ratio of the capacity to the initial capacity remains over 0.6. The battery shows a good cyclic characteristic.

As described above, polybiphenylaniline was used for the active material of the positive electrode. Further, the dopant doped into polybiphenylaniline was the sulfuric acid which has a single site of the group dissociating proton. The sulfuric acid is small in dopant size, thereby increasing the doping rate and also improve the reactivity of the oxidation reduction reactions. The ratio of the actual capacity to the theoretical capacity is high. For those reasons, the battery is chemically stable. The battery has the good cyclic characteristic. The battery shows a slow self-discharge. The sulfuric acid as the dopant doped to the polybiphenylaniline improves the reactivity of polybiphenylaniline. The sulfuric acid has a small molecular weight, whereby a high capacity in a unit weight of the active material can be obtained.

Polybiphenylaniline has a structure which comprises a skeleton of polyaniline introduced with benzene-rings. This polybiphenylaniline was doped with a dopant of the acid which has a single site of the group dissociating proton, where the dopant has a small size and a small molecular weight, whereby the doping rate is increased from 50% to 100%. The reactivity of the oxidation reduction reactions were also increased from 20% to 80%, whereby the ratio of the actual capacity to the theoretical capacity of the battery was also increased. Polyaniline is chemically stable and the battery using polyaniline shows a slow self-discharge and a good cyclic characteristic. Polybiphenylaniline has a similar chemical structure to polyaniline. Polybiphenylaniline is also chemically stable and shows a slow self-discharge the battery using polybiphenylaniline shows a slow self-discharge and a good cyclic characteristic.

### Comparative Example 1

Polyaniline was used as the active material of the positive electrode. Polyaniline was doped with a dopant of SO₄. ZnSO₄ was used as an electrolytic solution. Zn was used for the negative electrode.

The sheet-shaped positive electrode 2 may be formed as follows. Polyaniline as the active material and a vapor phase epitaxy carbon as a conductive auxiliary substance are mixed at a weight ratio of 4:1 to prepare a mixture. This mixture is further mixed with N-methylpyrolidone to adjust a slurry. The adjusted slurry is sufficiently stirred by a homogenizer and then formed to be a film on the sheet-shaped collector 1 by use of doctor-blade. The film on the sheet-shaped collector 1 is dried in vacuum at a temperature in the range of 120° C.-160° C. for one hour. The film is then pressed by a roll-press machine so that the film has a thickness of about 100 micrometers. The laminations of the film and the collector 1 are cut to form the positive electrode 2.

The battery was charged to measure various characteristics thereof. The secondary battery was charged in the range of 1-10C up to 1.5V at a constant current in the range of 1 mA/cm2. The secondary battery was discharged in the range of 1-10C at a constant current in the range of 1-10 mA/cm2, where a theoretical capacity was 108 Wh/kg per a unit weight of the active material of the positive electrode. At the discharge rate of 1C, the actual capacity was 26.04 Wh/kg per the weight of the active material of the positive electrode. At the discharge rate of 10C, the actual capacity was 7 Wh/kg per the weight of the active material of the positive electrode. A ratio of the actual capacity to the theoretical capacity at the discharge rate of 1C was high, for example, 25%. The ratio of the actual capacity to the theoretical capacity corresponds to the reactivity of the oxidation reduction reactions. The cyclic characteristics were also measured. A cyclic number necessary for dropping the capacity to 80% of the initial capacity of 26.04 Wh/kg was 1000. A capacity storage characteristic was also measured. After the battery was placed at 25° C. for 30 days, then the capacity was reduced to 50% of the initial capacity.

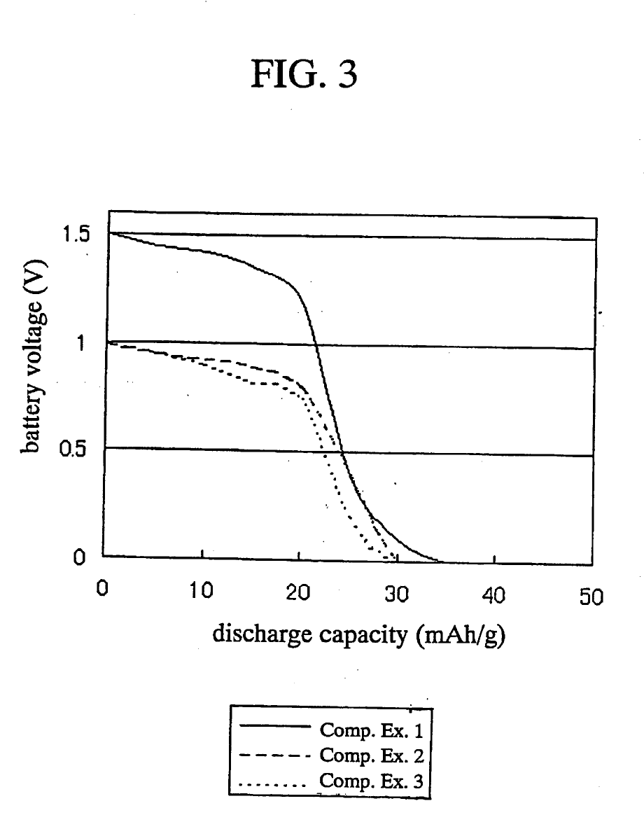

FIG. 3 is illustrative of voltage-discharge capacity characteristic of the above battery of this comparative example. The voltage of the battery is rapidly dropped at a high discharge capacity of about 20 mAh/g. Namely, the battery keeps high voltage levels but in the narrow range of discharge capacity.

FIG. 4 is illustrative of capacity-discharge current characteristic of the above battery of this comparative example. The capacity of the battery remains low versus the discharge current. The capacity remains under 20 mAh/g.

FIG. 5 is illustrative of variations of a ratio of the capacity to the initial capacity over the cycle number of the above battery of this example. As the cycle number is beyond 500, the ratio of the capacity to the initial capacity is rapidly decreased. At the cycle number is 1000, the ratio of the capacity to the initial capacity remains under 0.8. At the cycle number is 1500, the ratio of the capacity to the initial capacity remains under 0.7. At the cycle number is 3000, the ratio of the capacity to the initial capacity remains under 0.5. The battery shows an undesirable cyclic characteristic.

As described above, polyaniline was used for the active material of the positive electrode. Further, the dopant doped into polyaniline was the sulfuric acid which has a single site of the group dissociating proton. The sulfuric acid is small in dopant size. However, polyaniline has 20%-part which contributes the oxidation reduction reaction, thereby decreasing the doping rate and also deteriorate the reactivity of the oxidation reduction reactions. The ratio of the actual capacity to the theoretical capacity is low. For those reasons, the use of polyaniline as the active material of the positive electrode deteriorates the reactivity of oxidation reduction reactions, whereby a low capacity in a unit weight of the active material can be obtained.

### EXAMPLE 2

Polybiphenylaniline was used as the active material of the positive electrode. Polybiphenylaniline was doped with a dopant of SO₄. H₂SO₄ was used as an electrolytic solution. Polypyridine was used for the negative electrode.

The sheet-shaped positive electrode 2 may be formed as follows. Polybiphenylaniline as the active material and a vapor phase epitaxy carbon as a conductive auxiliary substance are mixed at a weight ratio of 4:1 to prepare a mixture. This mixture is further mixed with N-methylpyrolidone to adjust a slurry. The adjusted slurry is sufficiently stirred by a homogenizer and then formed to be a film on the sheet-shaped collector 1 by use of doctor-blade. The film on the sheet-shaped collector 1 is dried in vacuum at a temperature in the range of 120° C.-160° C. for one hour. The film is then pressed by a roll-press machine so that the film has a thickness of about 100 micrometers. The laminations of the film and the collector 1 are cut to form the positive electrode 2.

The sheet-shaped negative electrode 4 may be formed as follows. Polypyridine as the active material and a vapor phase epitaxy carbon as a conductive auxiliary substance are mixed at a weight ratio of 1:1 to prepare a mixture. This mixture is further mixed with a formic acid to adjust a slurry. The adjusted slurry is sufficiently stirred by a homogenizer and then, formed to be a film on the sheet-shaped collector 5 by use of doctor-blade. The film on the sheet-shaped collector 5 is dried in vacuum at a temperature in the range of 100° C.-140° C. for one hour. The film is then pressed by a roll-press machine so that the film has a thickness of about 100 micrometers. The laminations of the film and the collector 5 are cut and then a solid-state electrolyte of Nafion was coated thereunto, to form the negative electrode 4.

The battery was charged to measure various characteristics thereof. The secondary battery was charged in the range of 1-10C up to 1.0V at a constant current in the range of 1 mA/cm2. The secondary battery was discharged in the range of 1-10C at a constant current in the range of 1-10 mA/cm2, where a theoretical capacity was 102 Wh/kg per a unit weight of the active material of the positive electrode. At the discharge rate of 1C, the actual capacity was 76.05 Wh/kg per the weight of the active material of the positive electrode. At the discharge rate of 10C, the actual capacity was 45 Wh/kg per the weight of the active material of the positive electrode. A ratio of the actual capacity to the theoretical capacity at the discharge rate of 1C was high, for example, 75%. The ratio of the actual capacity to the theoretical capacity corresponds to the reactivity of the oxidation reduction reactions. The cyclic characteristics were also measured. A cyclic number necessary for dropping the capacity to 80% of the initial capacity of 76.05 Wh/kg was 2000. A capacity storage characteristic was also measured. After the battery was placed at 25° C. for 30 days, then the capacity was reduced to 85% of the initial capacity.

FIG. 2 is illustrative of voltage-discharge capacity characteristic of the above battery of this example. The voltage of the battery is dropped at a high discharge capacity over 70 mAh/g. Namely, the battery keeps high voltage levels in the wide range of discharge capacity.

FIG. 4 is illustrative of capacity-discharge current characteristic of the above battery of this example. The capacity of the battery is gently reduced as the discharge current is increased, but the capacity remains high range. At the discharge current was 2 mA/cm², the capacity was over 60 mAh/g. At the discharge current was 4 mA/cm², the capacity was 60 mAh/g. At the discharge current was 10 mA/cm², the capacity was 45 mAh/g. The battery shows a good capacity-discharge current characteristic.

FIG. 5 is illustrative of variations of a ratio of the capacity to the initial capacity over the cycle number of the above battery of this example. As the cycle number is beyond 1000, the ratio of the capacity to the initial capacity is gently decreased. At the cycle number is 2000, the ratio of the capacity to the initial capacity remains over 0.8. At the cycle number is 3000, the ratio of the capacity to the initial capacity remains over 0.7. The battery shows a good cyclic characteristic.

As described above, polybiphenylaniline was used for the active material of the positive electrode. Further, the dopant doped into polybiphenylaniline was the sulfuric acid which has a single site of the group dissociating proton. The sulfuric acid is small in dopant size, thereby increasing the doping rate and also improve the reactivity of the oxidation reduction reactions. The ratio of the actual capacity to the theoretical capacity is high. For those reasons, the battery is chemically stable. The battery has the good cyclic characteristic. The battery shows a slow self-discharge. The sulfuric acid as the dopant doped to the polybiphenylaniline improves the reactivity of polybiphenylaniline. The sulfuric acid has a small molecular weight, whereby a high capacity in a unit weight of the active material can be obtained.

Further, the sulfuric acid was used for the electrolytic solution to decrease a pH value of the electrolytic solution, whereby the reactivity of polybiphenylaniline is increased. The discharge at large capacity from the battery can be realized.

### Comparative Example 2

Polybiphenylaniline was used as the active material of the positive electrode. Polybiphenylaniline was doped with a dopant of naphthalene di-sulfonic acid. H₂SO₄ was used as an electrolytic solution. Polypyridine was used for the negative electrode.

The sheet-shaped positive electrode 2 may be formed as follows. Polybiphenylaniline as the active material and a vapor phase epitaxy carbon as a conductive auxiliary substance are mixed at a weight ratio of 4:1 to prepare a mixture. This mixture is further mixed with N-methylpyrolidone to adjust a slurry. The adjusted slurry is sufficiently stirred by a homogenizer and then formed to be a film on the sheet-shaped collector 1 by use of doctor-blade. The film on the sheet-shaped collector 1 is dried in vacuum at a temperature in the range of 120° C.-160° C. for one hour. The film is then pressed by a roll-press machine so that the film has a thickness of about 100 micrometers. The laminations of the film and the collector 1 are cut to form the positive electrode 2.

The sheet-shaped negative electrode 4 may be formed as follows. Polypyridine as the active material and a vapor phase epitaxy carbon as a conductive auxiliary substance are mixed at a weight ratio of 1:1 to prepare a mixture. This mixture is further mixed with a formic acid to adjust a slurry. The adjusted slurry is sufficiently stirred by a homogenizer and then formed to be a film on the sheet-shaped collector 5 by use of doctor-blade. The film on the sheet-shaped collector 5 is dried in vacuum at a temperature in the range of 100° C.-140° C. for one hour. The film is then pressed by a roll-press machine so that the film has a thickness of about 100 micrometers. The laminations of the film and the collector 5 are cut and then a solid-state electrolyte of Nafion was coated thereunto, to form the negative electrode 4.

The battery was charged to measure various characteristics thereof. The secondary battery was charged in the range of 1-10C up to 1.0V at a constant current in the range of 1 mA/cm2. The secondary battery was discharged in the range of 1-10C at a constant current in the range of 1-10 mA/cm2, where a theoretical capacity was 59.2 Wh/kg per a unit weight of the active material of the positive electrode. At the discharge rate of 1C, the actual capacity was 23 Wh/kg per the weight of the active material of the positive electrode. At the discharge rate of 10C, the actual capacity was 11 Wh/kg per the weight of the active material of the positive electrode. A ratio of the actual capacity to the theoretical capacity at the discharge rate of 1C was high, for example, 40%. The ratio of the actual capacity to the theoretical capacity corresponds to the reactivity of the oxidation reduction reactions. The cyclic characteristics were also measured. A cyclic number necessary for dropping the capacity to 80% of the initial capacity of 23 Wh/kg was 800. A capacity storage characteristic was also measured. After the battery was placed at 25° C. for 30 days, then the capacity was reduced to 20% of the initial capacity.

FIG. 3 is illustrative of voltage-discharge capacity characteristic of the above battery of this comparative example. The voltage of the battery is rapidly dropped at a high discharge capacity of about 20 mAh/g. Namely, the battery keeps high voltage levels but in the narrow range of discharge capacity.

FIG. 4 is illustrative of capacity-discharge current characteristic of the above battery of this comparative example. The capacity of the battery remains low versus the discharge current. The capacity remains under 20 mAh/g.

FIG. 5 is illustrative of variations of a ratio of the capacity to the initial capacity over the cycle number of the above battery of this example. As the cycle number is beyond 500, the ratio of the capacity to the initial capacity is rapidly decreased. At the cycle number is 1000, the ratio of the capacity to the initial capacity remains under 0.8. At the cycle number is 1500, the ratio of the capacity to the initial capacity remains under 0.5. The battery shows an undesirable cyclic characteristic.

As described above, polybiphenylaniline was used for the active material of the positive electrode. Further, the dopant doped into polybiphenylaniline was the naphthalene di-sulfonic acid which has multi-sites of the group dissociating proton. The naphthalene di-sulfonic acid is large in dopant size, thereby decreasing the doping rate and also deteriorate the reactivity of the oxidation reduction reactions. The ratio of the actual capacity to the theoretical capacity is low. For those reasons, the battery is chemically unstable. The battery has the undesirable cyclic characteristic. The battery does not show a slow self-discharge. The naphthalene di-sulfonic acid as the dopant doped to the polybiphenylaniline deteriorates the reactivity of polybiphenylaniline. The naphthalene di-sulfonic acid has a large molecular weight, whereby a low capacity in a unit weight of the active material can be obtained.

### EXAMPLE 3

Polybiphenylaniline was used as the active material of the positive electrode. Polybiphenylaniline was doped with a dopant of trifluoromethane sulfonic acid CF₃SO₃.H₂SO₄ was used as an electrolytic solution. Polypyridine was used for the negative electrode.

The sheet-shaped positive electrode 2 may be formed as follows. Polybiphenylaniline as the active material and a vapor phase epitaxy carbon as a conductive auxiliary substance are mixed at a weight ratio of 4:1 to prepare a mixture. This mixture is further mixed with N-methylpyrolidone to adjust a slurry. The adjusted slurry is sufficiently stirred by a homogenizer and then formed to be a film on the sheet-shaped collector 1 by use of doctor-blade. The film on the sheet-shaped collector 1 is dried in vacuum at a temperature in the range of 120° C.-160° C. for one hour. The film is then pressed by a roll-press machine so that the film has a thickness of about 100 micrometers. The laminations of the film and the collector 1 are cut to form the positive electrode 2.

The sheet-shaped negative electrode 4 may be formed as follows. Polypyridine as the active material and a vapor phase epitaxy carbon as a conductive auxiliary substance are mixed at a weight ratio of 1:1 to prepare a mixture. This mixture is further mixed with a formic acid to adjust a slurry. The adjusted slurry is sufficiently stirred by a homogenizer and then formed to be a film on the sheet-shaped collector 5 by use of doctor-blade. The film on the sheet-shaped collector 5 is dried in vacuum at a temperature in the range of 100° C.-140° C. for one hour. The film is then pressed by a roll-press machine so that the film has a thickness of about 100 micrometers. The laminations of the film and the collector 5 are cut and then a solid-state electrolyte of Nafion was coated thereunto, to form the negative electrode 4.

The battery was charged to measure various characteristics thereof. The secondary battery was charged in the range of 1-10C up to 1.0V at a constant current in the range of 1-10 mA/cm2. The secondary battery was discharged in the range of 1-10C at a constant current in the range of 1-10 mA/cm2, where a theoretical capacity was 85.6 Wh/kg per a unit weight of the active material of the positive electrode. At the discharge rate of 1C, the actual capacity was 81 Wh/kg per the weight of the active material of the positive electrode. At the discharge rate of 10C, the actual capacity was 60 Wh/kg per the weight of the active material of the positive electrode. A ratio of the actual capacity to the theoretical capacity at the discharge rate of 1C was high, for example, 95%. The ratio of the actual capacity to the theoretical capacity corresponds to the reactivity of the oxidation reduction reactions. The cyclic characteristics were also measured. A cyclic number necessary for dropping the capacity to 80% of the initial capacity of 81 Wh/kg was 1500. A capacity storage characteristic was also measured. After the battery was placed at 25° C. for 30 days, then the capacity was reduced to 70% of the initial capacity.

FIG. 2 is illustrative of voltage-discharge capacity characteristic of the above battery of this example. The voltage of the battery is dropped at a high discharge capacity over 70 mAh/g. Namely, the battery keeps high voltage levels in the wide range of discharge capacity.

FIG. 4 is illustrative of capacity-discharge current characteristic of the above battery of this example. The capacity of the battery is gently reduced as the discharge current is increased, but the capacity remains high range. At the discharge current was 2 mA/cm², the capacity was over 80 mAh/g. At the discharge current was 6 mA/cm², the capacity was 70 mAh/g. At the discharge current was 10 mA/cm², the capacity was 60 mAh/g. The battery shows a good capacity-discharge current characteristic.

FIG. 5 is illustrative of variations of a ratio of the capacity to the initial capacity over the cycle number of the above battery of this example. As the cycle number is beyond 1000, the ratio of the capacity to the initial capacity is gently decreased. At the cycle number is 1500, the ratio of the capacity to the initial capacity remains over 0.8. At the cycle number is 3000, the ratio of the capacity to the initial capacity remains over 0.7. The battery shows a good cyclic characteristic.

As described above, polybiphenylaniline was used for the active material of the positive electrode. Further, the dopant doped into polybiphenylaniline was the trifluoromethane sulfonic acid which has a single site of the group dissociating proton. The trifluoromethane sulfonic acid is small in dopant size, thereby increasing the doping rate and also improve the reactivity of the oxidation reduction reactions. The ratio of the actual capacity to the theoretical capacity is high. For those reasons, the battery is chemically stable. The battery has the good cyclic characteristic. The battery shows a slow self-discharge. The trifluoromethane sulfonic acid as the dopant doped to the polybiphenylaniline improves the reactivity of polybiphenylaniline. The trifluoromethane sulfonic acid has a small molecular weight, whereby a high capacity in a unit weight of the active material can be obtained.

Further, the sulfuric acid was used for the electrolytic solution to decrease a pH value of the electrolytic solution, whereby the reactivity of polybiphenylaniline is increased. The discharge at large capacity from the battery can be realized.

### Comparative Example 3

This comparative example 3 is different in dopant from the example 3. Polybiphenylaniline was used as the active material of the positive electrode. Polybiphenylaniline was doped with a dopant of a polyvinyl sulfonic acid. H₂SO₄ was used as an electrolytic solution. Polypyridine was used for the negative electrode.

The battery was charged to measure various characteristics thereof. The secondary battery was charged in the range of 1-10C up to 1.0V at a constant current in the range of 1-10 mA/cm2. The secondary battery was discharged in the range of 1-10C at a constant current in the range of 1-10 mA/cm2, where a theoretical capacity was 98.2 Wh/kg per a unit weight of the active material of the positive electrode. At the discharge rate of 1C, the actual capacity was 19.6 Wh/kg per the weight of the active material of the positive electrode. At the discharge rate of 10C, the actual capacity was 10 Wh/kg per the weight of the active material of the positive electrode. A ratio of the actual capacity to the theoretical capacity at the discharge rate of 1C was high, for example, 20%. The ratio of the actual capacity to the theoretical capacity corresponds to the reactivity of the oxidation reduction reactions. The cyclic characteristics were also measured. A cyclic number necessary for dropping the capacity to 80% of the initial capacity of 19.6. Wh/kg was 500. A capacity storage characteristic was also measured. After the battery was placed at 25° C. for 30 days, then the capacity was reduced to 10% of the initial capacity.

FIG. 3 is illustrative of voltage-discharge capacity characteristic of the above battery of this comparative example. The voltage of the battery is rapidly dropped at a high discharge capacity of about 20 mAh/g. Namely, the battery keeps high voltage levels but in the narrow range of discharge capacity.

FIG. 4 is illustrative of capacity-discharge current characteristic of the above battery of this comparative example. The capacity of the battery remains low versus the discharge current. The capacity remains under 20 mAh/g.

FIG. 5 is illustrative of variations of a ratio of the capacity to the initial capacity over the cycle number of the above battery of this example. As the cycle number is beyond 500, the ratio of the capacity to the initial capacity is rapidly decreased. At the cycle number is 500, the ratio of the capacity to the initial capacity is 0.8. At the cycle number is 1000, the ratio of the capacity to the initial capacity is 0.6. The battery shows an undesirable cyclic characteristic.

As described above, polybiphenylaniline was used for the active material of the positive electrode. Further, the dopant doped into polybiphenylaniline was the polyvinyl sulfonic acid which has multi-sites of the group dissociating proton. The polyvinyl sulfonic acid is large in dopant size, thereby decreasing the doping rate and also deteriorate the reactivity of the oxidation reduction reactions. The ratio of the actual capacity to the theoretical capacity is low. For those reasons, the battery is chemically unstable. The battery has the undesirable cyclic characteristic. The battery does not show a slow self-discharge. The polyvinyl sulfonic acid as the dopant doped to the polybiphenylaniline deteriorates the reactivity of polybiphenylaniline. The polyvinyl sulfonic acid has a large molecular weight, whereby a low capacity in a unit weight of the active material can be obtained.

Whereas modifications of the present invention will be apparent to a person having ordinary skill in the art, to which the invention pertains, it is to be understood that embodiments as shown and described by way of illustrations are by no means intended to be considered in a limiting sense. Accordingly, it is to be intended to cover by claims all modifications which fall within the spirit and scope of the present invention.

What is claimed is:

1. A conductive polymer comprising a polybiphenylaniline.

2. The conductive polymer as claimed in claim 1, wherein said polybiphenylaniline is represented by the following general formula: 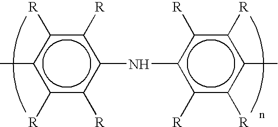
where R is any one of hydrogen atom, halogen atom, hydroxyl groups, carboxyl groups, sulfonic groups, sulfuric groups, nitro groups, cyano groups, alkyl groups, aryl groups, alkoxyl groups, aryloxy groups, amino groups, alkylthio groups, arylthio groups, and heterocyclic groups, provided that individuals of R are not limited to be the same.

3. The conductive polymer as claimed in claim 1, wherein said polybiphenylaniline is doped with dopant comprising at least an acid having a single site of a group which dissociates proton.

4. The conductive polymer as claimed in claim 3, wherein said acid is selected from the group consisting of a sulfuric acid, a hydrochloric acid, a perchloric acid, a benzene sulfonic acid, a p-toluene sulfonic acid, benzenesulfonyl chloride, a dodecylbenzene sulfonic acid, a methane sulfonic acid, a trifluoromethane sulfonic acid, a butane sulfonic acid, a trichlorobenzene sulfonic acid, a naphthalene sulfonic acid, a perfluorobutane sulfonic acid, and a perfluorooctane sulfonic acid.

5. The conductive polymer as claimed in claim 1, wherein said polybiphenylaniline is doped with a dopant comprising at least one selected from acids excluding polymer acids.

6. The conductive polymer as claimed in claim 1, wherein said conductive polymer is used as an active material for an electrode.

7. The conductive polymer as claimed in claim 1, wherein said conductive polymer is used as an electromagnetic shielding material.

8. The conductive polymer as claimed in claim 1, wherein said conductive polymer is used for a conductive film.

9. The conductive polymer as claimed in claim 1, wherein said conductive polymer is used for an electro-chromic material.

10. The conductive polymer as claimed in claim 1, wherein said conductive polymer is used for an anti-static material.

11. An active material including a conductive material of claim 1.

12. An electrode using an active material of claim 11.

13. A battery using an electrode of claim 12.

14. The battery as claimed in claim 13, wherein said battery uses an electrolytic solution including an electrolyte of the same acid as doped into polybiphenylaniline.

15. An electrode using a conductive material of claim 1.

16. The electrode as claimed in claim 15, wherein said electrode is used in a semiconductor device.

17. The electrode as claimed in claim 15, wherein said electrode is used in an electronic device.

18. The electrode as claimed in claim 15, wherein said electrode is used in an electric device.
